(19) United States
(12) Patent Application Publication
(10) Pub. No.: US 2023/0130554 A1
(43) Pub. Date: Apr. 27, 2023

(54) SCALABLE PHOTONIC SYSTEM FOR OPERATING RADIO FREQUENCY DEVICES AT CRYOGENIC TEMPERATURES

(71) Applicant: Bleximo Corp., Berkeley, CA (US)

(72) Inventors: Alexander Tselikov, Berkeley, CA (US); Alexei Marchenkov, Berkeley, CA (US)

(21) Appl. No.: 17/733,665

(22) Filed: Apr. 29, 2022

Related U.S. Application Data
(60) Provisional application No. 63/182,978, filed on May 2, 2021.

(51) Int. Cl. H04B 10/70; H04B 10/50; H04B 10/2575

(52) U.S. Cl. CPC H04B 10/70; H04B 10/503; H04B 10/25759

(57) ABSTRACT

A photonic control system is disclosed for optical control of superconducting RF structures. The photonic control system includes an optical light source transmitter including a laser and an RF driver supplying an optical signal. An optical fiber assembly is optically coupled to the optical light source transmitter. A photodetector is optically coupled to the optical light source transmitter via the optical fiber. The photodetector converts the optical signal to an RF signal. A photonically controlled superconducting RF structure such as a qubit or a readout resonator receives the RF signal from the photodetector.

### PRIORITY CLAIM

The present disclosure claims priority to and the benefit of U.S. Provisional Application Ser. No. 63/182,978, filed on May 2, 2021. The contents of that application are hereby incorporated by reference in their entirety.

### TECHNICAL FIELD

The present disclosure generally relates to the delivery and distribution of optical signals to devices and systems operating at cryogenic temperatures and converting the optical signals to radio frequency (RF) signals and, more specifically, to a system for controlling and reading the status of superconducting quantum bits (qubits) in superconducting quantum processors.

### BACKGROUND

Quantum based supercomputing is based on changing the state of quantum bits. Such supercomputing is magnitudes faster than existing solid-state based computing devices. However, one challenge is being able to control and read the state of the quantum bits.

Currently, a commercial off-the-shelf photodiode placed at milli-Kelvin temperatures allows the ability to control and read out the state of single superconducting quantum bits. However, the system has limited scalability since the heat dissipation at the working temperatures of superconducting qubits (typically, below 50 mK) scales rapidly with the duty cycle and exceeds the cooling power of commercial dilution refrigerators at low qubit counts.

Thus, there is a need for an optical control system that may be scaled to convert optical signals to RF signals for multiple RF superconducting elements. There is a further need for a photonic control system that can address individual RF superconducting elements operating at cryogenic temperatures. There is a further need for a photonic control system that allows operating cryogenic RF circuits at much lower power than that required by conventional coaxial RF cables.

### SUMMARY

The term embodiment and like terms, e.g., implementation, configuration, aspect, example, and option, are intended to refer broadly to all of the subject matter of this disclosure and the claims below. Statements containing these terms should be understood not to limit the subject matter described herein or to limit the meaning or scope of the claims below. Embodiments of the present disclosure covered herein are defined by the claims below, not this summary. This summary is a high-level overview of various aspects of the disclosure and introduces some of the concepts that are further described in the Detailed Description section below. This summary is not intended to identify key or essential features of the claimed subject matter. This summary is also not intended to be used in isolation to determine the scope of the claimed subject matter. The subject matter should be understood by reference to appropriate portions of the entire specification of this disclosure, any or all drawings, and each claim.

An embodiment of the present disclosure relates to a photonic control system including an optical light transmitter system having a light source configured to supply an optical control signal (pulse). An optical fiber assembly is optically coupled to the optical light transmitter system. A photodetector is optically coupled to the optical light source transmitter via the optical fiber assembly. The photodetector converts the optical signal to an RF signal. At least one superconducting chip includes one or more superconducting RF structure(s) configured to receive RF control signals from the photodetector.

A further implementation of the example control system is an embodiment where the one or more RF structures are configured to be controlled by the RF signal responsive to the optical control signal. Another implementation is where the superconducting chip includes the photodetector. Another implementation is where the control system includes a photonic chip including the photodetector. Another implementation is where the photonic chip and superconducting chip are flip chip bonded. Another implementation is where the photonic chip includes an optical waveguide configured to distribute the optical control signal to the photodetector. Another implementation is where the output of the photodetector is coupled to the superconducting RF structure via a power optimized RF network. The power optimized RF network includes resistive, inductive and capacitive elements and the elements of the RF network are in either a lumped or distributed configuration. Another implementation is where wherein the photodetector and the optimized RF network are positioned in the vicinity of the RF structures. Another implementation is where the RF network is coupled with the RF element capacitively, inductively, or both. Another implementation is where the RF network includes a load circuit and a matching circuit. Another implementation is where the matching circuit and load circuits are chosen to match the impedance of the photodetector at an operating frequency bandwidth of the superconducting RF structure. Another implementation is where the photodetector and the optimized RF network are positioned in the vicinity of the RF structure. Another implementation is where the RF structure is one of a qubit or a readout resonator. Another implementation is where the photonic chip includes a micro-lens array optical coupled to the optical fiber assembly and a tuning mirror to direct the received optical control signal. Another implementation is where the optical signal is a wavelength division multiplexed signal and the photonic chip includes an arrayed Wave Grating to demultiplex the wavelength division multiplexed signal to a plurality of RF structures. Another implementation is where the optical transmitter system includes lasers and RF drivers. The RF drivers are configured to drive the lasers with control signals to drive the superconducting RF structures. The lasers are one of a vertical-cavity surface-emitting laser (VCSEL) or a distributed feedback (DFB) laser. Another implementation is where the laser is one of a plurality of lasers arranged in a linear or 2D grid and are optically coupled to the optical fiber. The optical fiber assembly is one of a multimode optical fiber, a single-mode multicore optical fiber, a 2D multi-fiber, or a fiber ribbon. Another implementation is where the optical transmitter system is communicatively coupled with the photodetectors. Another implementation is where the optical transmitter system includes a wavelength division multiplexer combiner coupled to the laser to control the RF structures.

Another disclosed example embodiment is a photonic system including at least one optical transmitter system at room temperature configured to generate optical control signals. A plurality of photonically controlled RF systems at cryogenic temperatures each comprise a photonic chip and at least one superconducting chip. A plurality of optical fiber assemblies couples the optical control signals generated by the optical transmitter to each of the photonically controlled RF systems.

A further implementation of the example photonic system is an embodiment where the photonic chip includes a photodetector optically coupled to the optical light source transmitter via the optical fiber assembly. Another implementation is where the at least one superconducting chip includes one or more superconducting RF structure(s) configured to receive the RF signal responsive to the optical control signal from the photodetector. Another implementation is where the one or more RF structures are configured to be controlled by the RF signal responsive to the optical control signal. Another implementation is where the photonic chip and superconducting chip are flip-chip bonded. Another implementation is where the photonic chip includes an optical waveguide configured to distribute the optical control signal to the photodetector. Another implementation is where the output of the photodetector is coupled to the superconducting RF structure via a power optimized RF network. The power optimized RF network includes resistive, inductive and capacitive elements and the elements of the RF network are in either a lumped or distributed configuration. Another implementation is where the photodetector and the optimized RF network are positioned in the vicinity of the RF structure. Another implementation is where the RF network is coupled with the superconducting RF structure capacitively, inductively, or both. Another implementation is where the RF network includes a load circuit and a matching circuit. Another implementation is where the matching circuit and load circuits are configured so as to match the impedance of the photodetector at the frequency bandwidth of the superconducting RF structure to reduce power consumption. Another implementation is where the RF structure is one of a qubit or a readout resonator. Another implementation is where the photonic chip includes a micro-lens array optical coupled to the optical fiber assembly and a tuning mirror to direct the received optic control signal.

The above summary is not intended to represent each embodiment or every aspect of the present disclosure. Rather, the foregoing summary merely provides an example of some of the novel aspects and features set forth herein. The above features and advantages, and other features and advantages of the present disclosure, will be readily apparent from the following detailed description of representative embodiments and modes for carrying out the present invention, when taken in connection with the accompanying drawings and the appended claims. Additional aspects of the disclosure will be apparent to those of ordinary skill in the art in view of the detailed description of various embodiments, which is made with reference to the drawings, a brief description of which is provided below.

### BRIEF DESCRIPTION OF THE DRAWINGS

The disclosure, and its advantages and drawings, will be better understood from the following description of representative embodiments together with reference to the accompanying drawings. These drawings depict only representative embodiments, and are therefore not to be considered as limitations on the scope of the various embodiments or claims.

FIG. 1A illustrates a schematic representation of an example photonic control system that can address individual RF elements operating at cryogenic temperatures.

FIG. 1B illustrates a schematic representation of another photonic control system that can address individual RF elements operating at cryogenic temperatures;

FIG. 2 illustrates an example arrangement of the lasers shown in the systems shown in FIGS. 1A-1B;

FIG. 3 illustrates an example of 1D (fiber ribbon) or 2D (fiber array) optical assembly of the cable in the systems shown in FIGS. 1A-1B;

FIG. 4 shows an example of silicon photonics optical waveguides used to distribute the light to locations on an example cryogenic silicon photonics chip in FIG. 1A;

FIG. 5 shows an example of optical coupling to silicon photonics waveguides used in the system shown in FIG. 1A;

FIG. 6 shows an example of the system in FIG. 1A using a single fiber using wavelength division multiplexing (WDM);

FIG. 7 is a block diagram of an example optically driven qubit control and readout circuits for the photonically controlled RF system inside the system in FIG. 1A;

FIG. 8A shows an example representation of a photodetector with an unmatched impedance and a resistive load;

FIG. 8B shows an example representation of a photodetector that is impedance-matched to a load;

FIG. 9A shows an equivalent circuit representation of the photodetector with an unmatched impedance;

FIG. 9B shows an equivalent circuit representation of the coupling structure and a qubit;

FIG. 10 shows an implementation of a superconducting qubit cell, including a readout resonator, using an optical control and readout; and

FIG. 11 shows an example implementation of a system consisting of multiple optically controlled systems such as those shown in FIGS. 1A-1B operating together.

### DETAILED DESCRIPTION

Various embodiments are described with reference to the attached figures, where like reference numerals are used throughout the figures to designate similar or equivalent elements. The figures are not necessarily drawn to scale and are provided merely to illustrate aspects and features of the present disclosure. Numerous specific details, relationships, and methods are set forth to provide a full understanding of certain aspects and features of the present disclosure, although one having ordinary skill in the relevant art will recognize that these aspects and features can be practiced without one or more of the specific details, with other relationships, or with other methods. In some instances, well-known structures or operations are not shown in detail for illustrative purposes. The various embodiments disclosed herein are not necessarily limited by the illustrated ordering of acts or events, as some acts may occur in different orders and/or concurrently with other acts or events. Furthermore, not all illustrated acts or events are necessarily required to implement certain aspects and features of the present disclosure.

For purposes of the present detailed description, unless specifically disclaimed, and where appropriate, the singular includes the plural and vice versa. The word “including” means “including without limitation.” Moreover, words of approximation, such as “about,” “almost,” “substantially,” “approximately,” and the like, can be used herein to mean “at,” “near,” “nearly at,” “within 3-5% of,” “within acceptable manufacturing tolerances of,” or any logical combination thereof. Similarly, terms “vertical” or “horizontal” are intended to additionally include “within 3-5% of” a vertical or horizontal orientation, respectively. Additionally, words of direction, such as “top,” “bottom,” “left,” “right,” “above,” and “below” are intended to relate to the equivalent direction as depicted in a reference illustration; as understood contextually from the object(s) or element(s) being referenced, such as from a commonly used position for the object(s) or element(s); or as otherwise described herein.

The present disclosure relates to a photonic system that delivers control signals to superconducting radio frequency (RF) elements and circuits operating at cryogenic temperatures. For example, optical signals are provided to adequately matched, low-power individual photodetectors or photodetector arrays used to manage cryogenic RF elements, such as qubits or resonators. In another example, the control signals are delivered to photodetectors integrated onto an RF superconducting chip. The optimized design allows operating cryogenic RF circuits at much lower power than conventional coaxial RF cables, resulting in significantly scaling up the number of RF elements on a cryogenic RF chip, e.g., the number of superconducting qubits on a superconducting quantum processor.

In this example, an array of vertical-cavity surface-emitting lasers (VCSELs) is set at room temperature, with each laser independently driven by electrical signals at frequencies in the 4-12 GHz range. These lasers produce radiation in the 780-1550 nm band, which is compatible with semiconductor photodetectors, fiber optics, and silicon photonics structures used in telecommunications and sensing applications. The laser array may be coupled to a multimode fiber or multi-fiber ribbon, which is coupled to a cryogenic chip on the other end. Optical fibers are coupled to silicon photonics waveguides, and modulated optical signals are delivered to integrated semiconductor photodetectors distributed across a quantum processor. The photodetectors allow RF control of the superconducting RF elements such as changing the state of a qubit and reading a qubit state through a resonator.

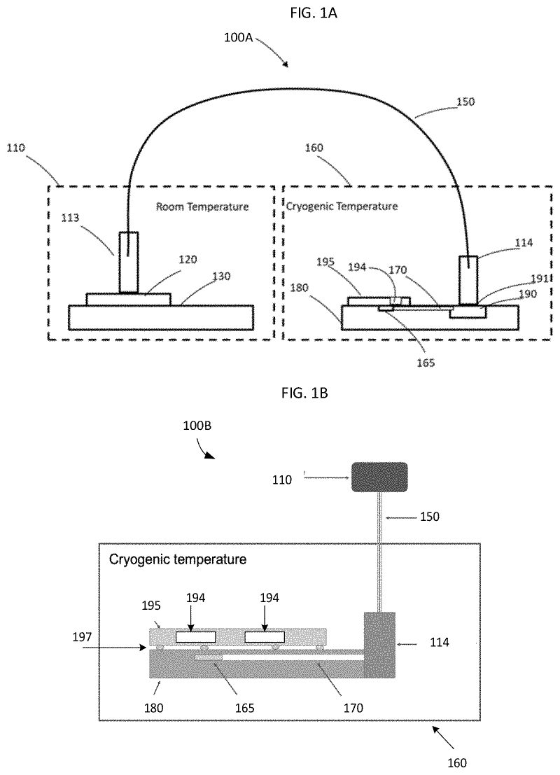

FIG. 1A illustrates a schematic representation of an example photonic control system 100A that can address individual RF structures operating at cryogenic temperatures. The system 100A in FIG. 1A consists of an optical transmitter system 110 operating at room temperature linked to a photonically controlled RF system 160 such as a superconducting quantum processor operating at cryogenic temperatures via an optical fiber/cable assembly 150.

FIG. 1B illustrates a schematic representation of another example photonic control system 100B that utilizes flip-chip bonding for internal components, and that can address individual RF structures operating at cryogenic temperatures. In the system 100B, the optical transmitter system 110 is located externally from the photonically controlled RF system 160 via the optical fiber/cable assembly 150. Like elements in FIG. 1B are labeled with identical element numbers as their counterparts in FIG. 1A.

The optical transmitter system 110 in FIG. 1A consists of an array of lasers 120 coupled to the optical fiber/cable assembly 150 using an optical coupler 113. In this example, the lasers 120 are vertical-cavity surface-emitting lasers (VCSELs) operating at room temperature. Other suitable types of lasers may be used. The lasers 120 are driven by RF drivers 130. The RF drivers 130 generate signals to modulate the lasers 120. The RF drivers 130 can be implemented using microprocessors, FPGA (field-programmable gate arrays), ASIC (application-specific integrated circuits), and other like devices, or a combination of these.

The optical transmitter system 110 operates at room temperature while the photonically controlled RF system 160 operates at cryogenic temperatures. The photonically controlled RF system 160 in this example has a cryogenic photonics chip 180 that includes integrated photodetectors 165 and a superconducting chip 195. The photonics chip 180 and superconducting chip 195 are primarily manufactured on silicon substrates or wafers. Other wafers such as sapphire wafers can be used for the superconducting chip 195. Qubits and other RF structures, e.g., resonators, couplers, readout lines, etc. are typically manufactured on one side of the wafer. These structures are made of superconducting materials, such as Al, Nb, Ta, TiN, etc. In the preferred embodiment, the side with RF structures is facing (adjacent) the photonics chip 180. In some cases, silicon wafers may contain through-silicon vias. In this case, structures may be fabricated on both sides of the wafer and the electric contact (DC and RF) between them is made using via structures. All types of superconducting qubits, such as charge qubits (e.g., fixed- and tunable frequency transmons), flux qubits (e.g., fluxonium qubits), and phase qubits can be controlled by the proposed photonic system 100.

One end of the fiber assembly 150 is optically coupled to the optical transmitter system 110. The other end of the fiber assembly 150 is optically coupled to a cryogenic fiber coupling optics 114. The cryogenic fiber coupling optics 114 is optically coupled to an optical coupling site 190 and a set of tuning mirrors 191. The chip 180 includes silicon photonics waveguides 170 optically coupled to the integrated photodetectors 165 (waveguide photodetectors). The received optical signals from the optical fiber 150 are guided to the waveguide photodetectors 165 through the optical coupling site 190, the tuning mirrors 191, and the waveguides 170. The photodetectors 165 convert optical pulses into RF pulses and are coupled to an RF structure 194, such as qubits, via optimized antennas and impedance-matching circuits. The RF pulses are used to control the RF structure 194 operating on the RF superconducting chip 195. The term RF structure or RF element refers to any circuit such as a qubit, a readout resonator, a superconducting structure, etc., and its associated circuitry. In this example, the RF structures are superconducting and thus operate in a cryogenic environment. Such associated circuitry may be a Purcell filter operating at cryogenic temperatures inside the superconducting chip 195. There may be multiple RF structures 194 operating inside the superconducting chip 195. For example, the RF structures 194 (or qubits) can be assembled to form a superconducting quantum processor or other computing device.

As shown in FIG. 1B, the photonically controlled RF system 160 includes the cryogenic fiber coupling optics 114 that is optically coupled to the photonic chip 180 via a coupling site on the side of the chip 180. The preferred embodiment is a hybrid chip design with the photonic chip 180 and superconducting chip 195 being flip chip bonded together through flip-chip bumps or solder balls 197. The photodetectors 165 are integrated on the photonic chip 180. The photodetectors 165 are positioned in the vicinity of the RF structures 194 on the flip-chip bonded superconducting chip 195. In this example, the RF structures 194 are qubits, and other microwave-controlled structures (e.g., readout resonators). The photodetectors 165 convert optical pulses into RF pulses and are coupled to qubits via optimized antennas and impedance-matching circuits.

As shown in FIGS. 1A-1B, the photodetectors 165, and waveguides 170 (optical structures) are placed on the silicon photonics chip 180, and the RF structures 194 are placed on the superconducting chip 195. Alternatively, the RF structures 194 may be integrated into the photonics chip 180. Although the preceding discussion and diagram indicate a single RF superconducting chip 195, there may be multiple RF superconducting chips similar to the RF superconducting chip 195 integrated with the photonic chip 180. The antennas and impedance matching circuits (not explicitly shown in FIGS. 1A-1B) are optimized to operate at frequency ranges of interest and to minimize heat dissipation. In one embodiment, the antennas (or coupling structures) and matching circuits are integrated in the photonics chip 180. In one embodiment, the photonic chip 180 contains an arrayed waveguide grating (AWG) or optical de-multiplexer explained below.

The Vertical-cavity surface-emitting lasers (VCSELs) of the laser array 120 are widely used for communication and sensing applications. VCSELs could be produced in large quantities and made into an array with each element independently driven by an electrical RF signal at frequencies 5-10 GHz range. VCSELs produce power in the mW range in the wavelength range of 780-1550 nm. 1310-1550 nm wavelengths are compatible with different photodetectors, fiber optic, and silicon photonics infrastructure and are available from telecommunications and sensing applications. The amplitude response of the VCSELs can be linearized by using an appropriate pre-distortion driver such as the driver 130.

In this example, the laser array 120 includes a series of VCSELs arranged on a linear, or a 2D grid. The array of VSCELs is optically coupled through the optical coupler 113 to a multimode or single-mode multicore optical fiber such as the fiber 150, a 2D multi-fiber array, or a fiber ribbon, and directed to a cryogenic RF circuit such as the cryogenic RF system 160. To further increase the density of optical signals routed to the cryogenic RF system 160, each channel can carry wavelength division multiplexed (WDM) signals generated from a multiplexer on the optical transmitter 120 from an array of single-frequency lasers such as distributed feedback (DFB) lasers. The DFB lasers can be directly modulated at ˜5-10 GHz frequency to produce the up-converted qubit drive signal. The systems 100A and 100B in this example use silicon photonics. One fiber or one fiber bundle may be used for the fiber 150 to deliver signals to multiple cryogenic RF elements by using silicon photonics waveguides at the cryogenic photonics chip 180 and arrayed waveguide grating (AWGs).

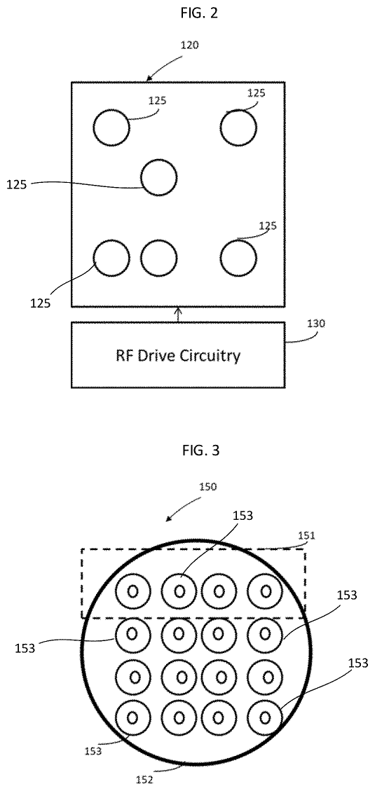

FIG. 2 illustrates an example arrangement of the laser array 120 in the systems 100A and 100B in FIGS. 1A and 1B. The laser array 120 includes multiple lasers 125 (e.g., a VCSEL array) arranged so each laser 125 is coupled to a single photodetector operating inside the photonically controlled RF system 160 in FIGS. 1A-1B. Each of the lasers 125 are driven by the RF drive circuitry 130 to control or read the RF structure 194. Alternatively, the laser array 120 may consist of a WDM (wavelength division multiplexing) combiner that allows the launching of multiple wavelengths onto a single fiber such as the fiber 150 and thus allows for a single laser to be coupled with multiple photodetectors in the photonically controlled RF system 160 in FIGS. 1A-1B.

FIG. 3 illustrates an example of a 1D (Fiber ribbon) or a 2D (multi-Fiber) optical assembly of the optical fiber assembly 150 in the systems 100A and 100B in FIGS. 1A and 1B. The fiber optical assembly 150 can be arranged in a 1D format (indicated by a rectangular box 151) or a 2D assembly shown as a circle 152. The assembly 150 can consist of either single-mode or multi-mode fibers 153. The optical fiber assembly 150 can consist of a single-mode core of a multicore optical fiber in one embodiment. The assembly 150 is designed to match the lasers in the laser array 120.

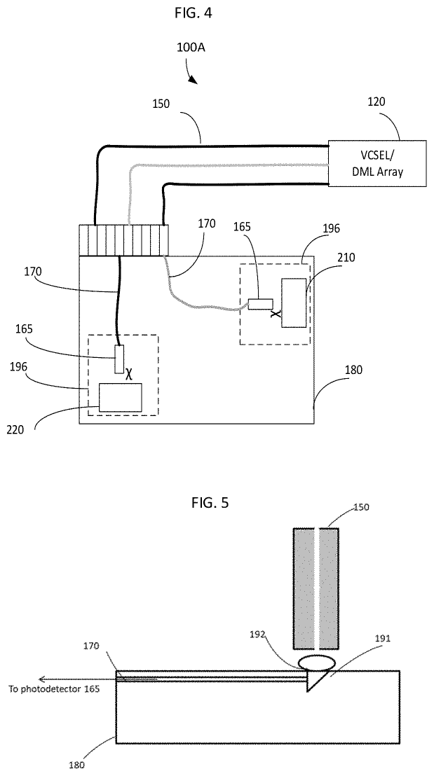

FIG. 4 shows an example of the silicon photonics optical waveguides 170 in the system 100A and system 100B that are used to distribute the optical signals to multiple locations on a cryogenic silicon photonics chip such as the photonics chip 180 in FIG. 1A or FIG. 1B. The optical fiber 150 delivers multiple signals and is coupled to a series of silicon photon waveguides such as the waveguides 170. Each of the photon waveguides 170 deliver the optical signals to a corresponding integrated photodetector 165. Although only two photodetectors 165 and two waveguides 170 are shown in FIG. 4, it is to be understood there may be multiple photodetectors 165 and corresponding waveguides 170. In this example, the photodetectors 165 convert optical pulses into RF pulses and are coupled (shown as χ) to a qubit 210 or a resonator 220 via optimized antennas and impedance-matching circuits 196. Other waveguides may direct optical pulses to other photodetectors to convert the optical pulses into RF pulses for other circuits. A fiber ribbon 150 is coupled to an edge of the silicon photonic chip 180 in this embodiment. Other ways of optical coupling the silicon photonic chip 180 with the fibber ribbon 150 such as vertical coupling are possible.

FIG. 5 shows an example of a vertical optical coupling of the fiber assembly 150 to silicon photonics waveguides 170 used in the system 100A in FIG. 1A. A micro-lens array 192 is used to couple the light from the fiber 150 to the silicon photonics waveguides 170 that then deliver the light signals to the photodetectors 165. The tuning mirror 191 is etched onto the photonics chip 180. The tuning mirror 191 is lithographically placed at the waveguides 170 on the photonics chip 180 to guide the optical signals from optical fiber assembly 150 onto the waveguides 170.

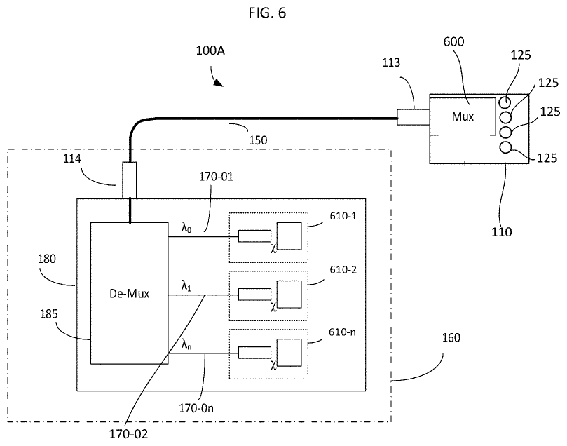

FIG. 6 shows an example of the system 100A and 100B in FIGS. 1A and 1B using a single optical fiber operating wavelength division multiplexing (WDM) signals. A series of single-mode lasers 125 such as DFB lasers drive a multiplexer or combiner 600 in the optical transmitter system 110. The laser output signals are operated at different wavelengths and are directly modulated by the combiner 600. Alternatively, the laser output signal may be modulated by external modulators. In this example, the laser light is output in different wavelengths and is launched into a single fiber 150 using the WDM (wavelength division multiplexing) combiner 600 and coupled to the photonics chip 180. The different wavelengths (λ0, λ1 . . . λn) are separated using an arrayed waveguide grating (AWG) 185 on the photonics chip 180. The wavelengths are delivered to the appropriate location to drive an RF structure 194 (e.g., qubit, readout resonator, etc.) A series of waveguides (170-01, 170-02, 170-0n) are terminated by integrated photodetectors such as the photodetectors 165 in FIGS. 1A-1B matched to the RF structures 194 of the quantum superconducting chip 195. The integrated photodetectors, matched antenna elements, and quantum devices, such as qubits shown in FIGS. 1A-1B are depicted as elements 610-1, 610-2, and 610-n in FIG. 6. The photonic chip 180 could have several such WDM systems, thus expanding the number of the addressable RF structures 194 that may be supported.

Combining arrangements shown in FIGS. 4-6 allow for a more extensive scaling of the number of RF structures on a single cryogenic device (e.g., a number of quantum bits on a quantum processor).

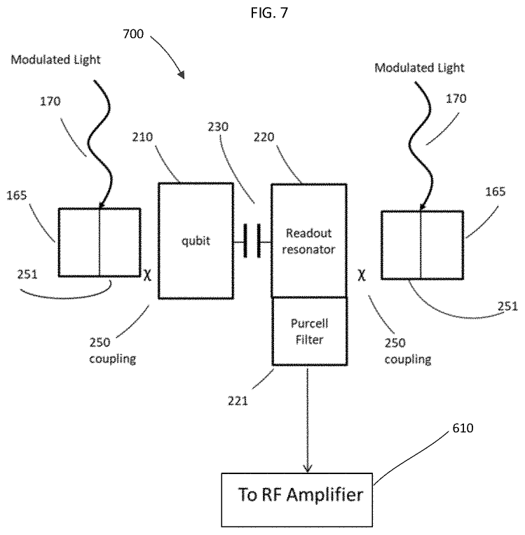

FIG. 7 is a block diagram of an example optically driven qubit control and readout circuit 700 for the photonically controlled RF system 160 inside the system 100. Impedance-matched coupling structures 250 are designed separately for driving the qubit 210 and the readout resonator 220 respectively. The coupling structures 250 are placed at an optimized location near the qubit 210 or the readout resonator 220. A photodetector 165 and a corresponding transmission line represented as a load 251 that is used to drive the qubit 210. Another photodetector 165 and corresponding transmission line represented as a load 251 is used to excite the readout resonator 220. A Purcell filter 221 may be integrated with the readout resonator 220. The output of the Purcell filter 221 is coupled to an RF amplifier 610 that amplifies the signal from the readout resonator 220 representing the state of the qubit 210. The output of the RF amplifier 610 may be passed to other components. A coupler 230 between the superconducting qubit 210 and the readout resonator 220 is used for the resonator 220 to read out the state of the qubit 210. Qubits such as the qubit 210 and readout out resonators such as the readout resonator 220 are coupled capacitively (typically, 5 to 50 fF) or inductively, or both.

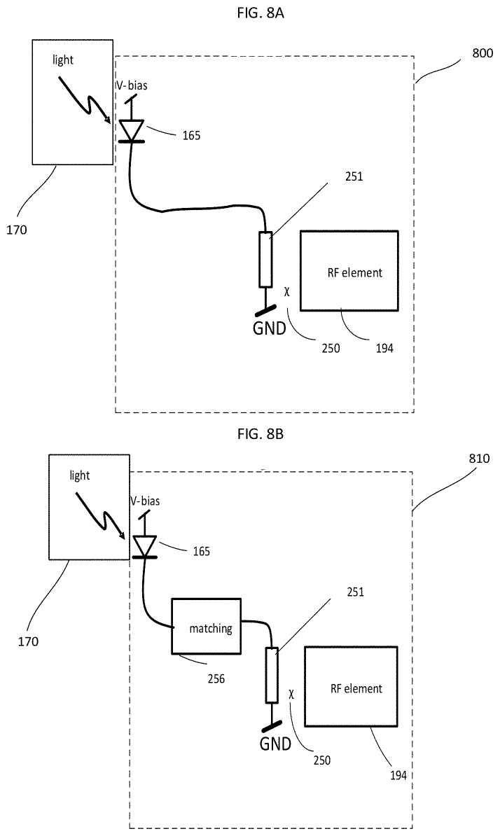

FIG. 8A shows an example representation of a circuit 800 that may be used for the circuits 610-1 to 610-n in FIG. 6. The matching circuit 800 includes a photodetector 165 with an unmatched resistive broadband load 251. A light signal is received from a waveguide 170 to the photodetector 165. A voltage bias may be applied to the photodetector 165. A coupling structure 250 controls the RF structure 194 from an RF signal converted by the photodetector 165 from the received optical signal. The capacitance of the photodetector 165 will limit the bandwidth of the photodetector 165. Increasing the value of the loading resistor (the load 251) will benefit the scalability and lower the power performance of the photonically controlled RF system 160. On the other hand, the RC constant will limit the operating frequency of the receiver. Therefore, a low capacitance photodetector, like a waveguide photodetector, is required for optimum performance. For example, photodetectors with a 5.5 fF capacitance are available, allowing a 3 dB bandwidth of 250 GHz into a 50 Ohm load or a 5-7 GHz bandwidth into 20-30 kOhm.

FIG. 8B shows a representation of an example matching circuit 810 that may be used for the circuits 610-0 to 610-n in FIG. 6. The matching circuit 810 has an impedance-matched photodetector 165 with a load 251 coupled to an RF structure 194 of the quantum RF system 160 via a coupling structure 250. The photodetector 165 converts optical signals received from the waveguide 170 to RF signals that drive the RF structure 194. The photodetector 165 has an impedance of Zd that is matched via a matching circuit 256 to the load 251. The matching circuit 256 could be implemented as distributed transmission line stubs or as lumped elements constituting an optimized RF network.

To scale up the number of qubits operating with a high duty cycle, the resistive part of the load impedance 251 in FIGS. 8A-8B should be maximized. However, the capacitance of the photodetector 165 will limit the available bandwidth of the link. The qubit drive circuits usually operate in a bandwidth of 1 GHz at the center frequency of 5-6 GHz. It is possible to match the impedance of the photodetector 165 to the impedance load 251 in a frequency band of interest (˜1 GHz) using a bandpass filter implemented as either distributed stubs or lumped elements. Matching the load impedance of the photodetector 165 with that of the load 251 will also reduce the power used to drive the qubits.

In FIG. 8B, a 50 Ohm impedance (characteristic impedance of the transmission line represented by the load 251) is used from the source to the open stub. Using the optical delivery link, the design has more flexibility in choosing the drive impedance. The matching circuit 256 and load circuit 251 may be selected to match the impedance of the photodetector 165 in a bandwidth of interest, thus reducing the required input power. Going further, the coupling structure χ (250) of the load 251 to the RF structure 194 could be considered for a matching design of the matching circuit 256. In the preferred embodiment, these structures are made of thin-film inductors, capacitors, and resistors.

The impedance Zdet of the photodetector 165 in FIGS. 8A-8B can be expressed as:

$${Z}_{det} = {R}_{det} + \frac{1}{{sC}_{det}}$$

where Rdet is the series resistance of the photodetector 165 and Cdet is its capacitance. For optimum power delivery to the load 251, the photodetector 165 should be loaded with an impedance equal to the complex conjugate impedance of the photodetector 165, (Zdet)*, so the maximum available power P delivered to the load is:

$$P = \frac{1}{8} \cdot \frac{I {det}^{2}}{( {w}^{2} {C}_{det}^{2} {R}_{det} )}$$

where Idet is the current through the photodetector 165 and w is the frequency of the RF structure 194. The matching circuit 256 can be implemented as a circuit consisting of either distributed elements or lumped elements. For example, the matching circuit 256 in FIG. 8B could be implemented as a grounded stub whose impedance is:

Zₜₗ=jZₒ tan(bL)

where Zo is the characteristic impedance of the transmission line, b is the wavenumber in the stub, and L is the stub length. The stub length should be smaller than the wavelength and may be used as a tunable inductor for conjugate impedance matching.

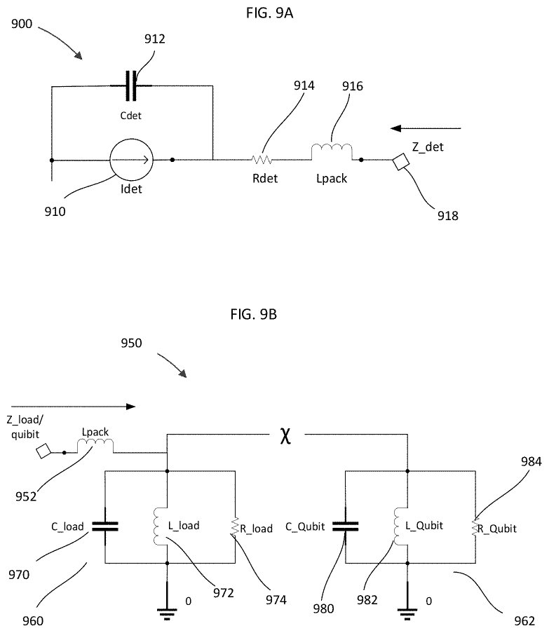

FIG. 9A shows a small signal equivalent circuit representation 900 of the photodetector 165 operated at a reverse bias. A current source 910 (Idet) is the current source due to the photocurrent, a capacitor 912 (Cdet) is the parasitic capacitance of the p-n junction of the photodetector 165, a resistor 914 (Rdet) is the parasitic series resistance of the photodetector 165 and an inductor 916 (Lpack) is the parasitic inductance due to packaging (such as inductance of wirebonds, or the inductance of a metal trace connecting the photodetector 165 to the matching and load circuits. An output impedance (Z_det) is then the output impedance of the photodetector 165.

FIG. 9B shows an equivalent circuit representation 950 of a matched load and the qubit Z_load/qubit. An inductor 952 (L_pack) is the parasitic inductance due to packaging, x is the coupling coefficient between a load such as the load 251 represented by a circuit 960 and an RF structure such as qubit 962 or a readout resonator. A capacitor 970 (C_load), an indicator 972 (L_load), and a resistor 974 (R_load) in parallel represent the matched load impedance. A capacitor 980 (C_qubit), an inductor 982 (L_qubit) and a resistor 984 (R_qubit) in parallel represent the qubit parameters.

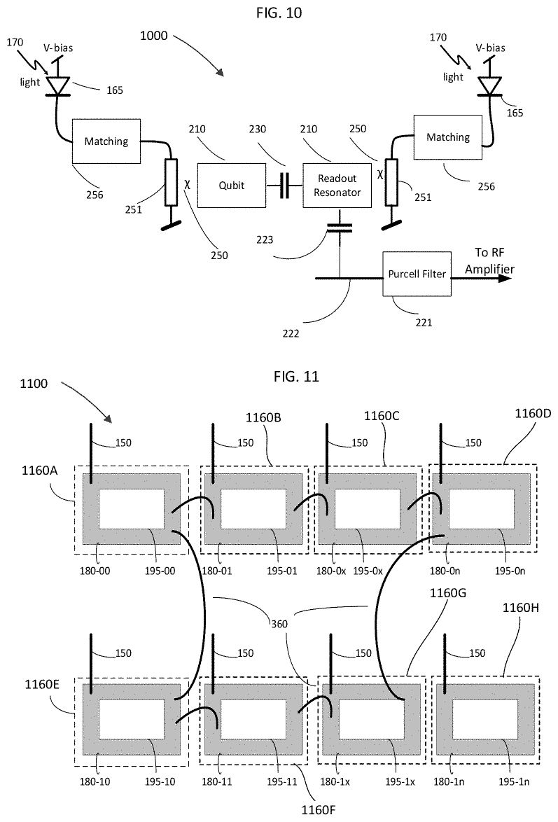

FIG. 10 shows an implementation of a superconducting qubit cell 1000 using optical control and readout as per the above described principles. The qubit cell 1000 includes a qubit such as the qubit 210 and a readout resonator such as the readout resonator 220. The qubit 210 and readout resonators 220 are dispersively coupled to each other capacitively, inductively, or both (230). The readout resonator 220 is coupled, in one embodiment, to a readout bus 222 capacitively, inductively, or both (223). The readout bus 222 may contain an optimized Purcell filter structure 221, that blocks the energy decay at the qubit frequency to the environment. The drive for the qubit 210 excitation and readout resonator 220 excitation is implemented using a photodetector 165 with the matching load 256 described in detail above.

Thus, an optical signal received from a waveguide 170 is converted into an RF signal via photodetector 165 with a matching filter 256 to a matching load 251 to drive the qubit 210. Similarly, an optical signal received from a waveguide 170 is converted into an RF signal via photodetector 165 with a matching filter 256 to a matching load 251 to drive the readout resonator 220.

FIG. 11 shows an example implementation of a photonically based system 1100 consisting of multiple photonic control systems such as the photonic control systems 160 in FIGS. 1A and 1B operating together. The system 1100 may be any type of superconducting computing system that takes advantage of superconducting speed. Thus, the system 1100 may be a memory device, a processor, a specific function logic circuit and the like. The system 1100 consists of multiple photonic control systems 1160A-1160H consisting of the photonic chips 180-00, 180-01, 180-0x, 180-0n, 180-10, 180-11, 180-1x, and 180-1n respectively and RF superconducting chips 195-01, 195-01, 195-0x, 195-0n, 195-10, 195-11, 196-1x, and 195-1n respectively. Each of the individual systems 1160A-1160H are communicatively coupled to each other via links 360. The links 360 can be electrical or optical and allow signal communication between the individual systems 1160A-1160H.

Any number of control systems similar to the systems 1160A-1160H may be arranged in the shown array format connected by links similar to the link 360. Other arrangements are possible. The individual systems 1160A-1160H can be controlled using optical cable/fibers 150 driven by one or more optical transmitter systems such as the optical transmitter system 110 shown in FIG. 1A or 1B.

The above described optical transmitter and control system allow high scalability and high qubit density. For example, around 1000 superconducting qubits can fit into a 100 mm by 100 mm area using these principles. A superconducting quantum processor based on the qubits in this arrangement can be mounted in a standard dilution refrigerator. 100 to 1000 qubits operating in the chips 195-nn along with the photonic chips 180-nn can be used as quantum processor even if the qubits are not error-corrected. Alternately, this number (100 to 1000) of qubits can be used to form a multi-processor quantum computing system. Therefore, what is shown in FIG. 11 may be viewed at as multiple processors coupled together to form a multi-processor quantum computing system or as an array of error-corrected logical qubits making a fault-tolerant quantum processor.

The above described design results in low crosstalk since RF control pulses are generated in the immediate vicinity of the qubits. Thus no microwave signal lines and wire-bonding loops are necessary and such significant crosstalk sources are eliminated.

The above described design also results in low heat dissipation since the local pulse generation allows qubit operation at much lower power than using conventional coaxial cables and attenuators.

The flip-chip bonding of the photonic chip 180 and the superconducting chip 195 in FIG. 1B allows the assembling of large superconducting chips from multiple smaller-area chips. The flip-bonding facilitates manufacturing small-scale chips with all qubits operational and matching specifications.

Instead of manually assembled cryogenic microwave control systems composed of a very large number of inter-component connections, cables, and other potential failure points, the present disclosure utilizes inexpensive, robust photonic components and established microfabrication technologies. This yields enhanced reliability and dramatically cut the overall cost of the processor control system.

Although the disclosed embodiments have been illustrated and described with respect to one or more implementations, equivalent alterations and modifications will occur or be known to others skilled in the art upon the reading and understanding of this specification and the annexed drawings. In addition, while a particular feature of the invention may have been disclosed with respect to only one of several implementations, such feature may be combined with one or more other features of the other implementations as may be desired and advantageous for any given or particular application.

While various embodiments of the present disclosure have been described above, it should be understood that they have been presented by way of example only, and not limitation. Numerous changes to the disclosed embodiments can be made in accordance with the disclosure herein, without departing from the spirit or scope of the disclosure. Thus, the breadth and scope of the present disclosure should not be limited by any of the above described embodiments. Rather, the scope of the disclosure should be defined in accordance with the following claims and their equivalents.

What is claimed is:

1. A photonic control system comprising:
an optical transmitter system comprising a light source configured to supply an optical control signal;
an optical fiber assembly optically coupled to the optical light transmitter system;
a photodetector optically coupled to the optical light source transmitter via the optical fiber assembly, the photodetector configured to convert the optical signal to an RF signal; and
at least one superconducting chip comprising one or more superconducting RF structure(s) configured to receive the RF signal responsive to the optical control signal from the photodetector.

2. The photonic control system of claim 1, wherein the one or more RF structures are configured to be controlled by the RF signal responsive to the optical control signal

3. The photonic control system of claim 1, wherein the superconducting chip includes the photodetector.

4. The photonic control system of claim 1, further comprising a photonic chip including the photodetector.

5. The photonic control system of claim 4, wherein the photonic chip and superconducting chip are flip-chip bonded.

6. The photonic control system of claim 4, wherein the photonic chip comprises optical waveguide configured to distribute the optical control signal to the photodetector.

7. The photonic control system of claim 1, wherein the output of the photodetector is coupled to the superconducting RF structure via a power optimized RF network comprising resistive, inductive and capacitive elements and where the elements of the RF network are in either a lumped or distributed configuration.

8. The photonic control system of claim 7, wherein the photodetector and the optimized RF network are positioned in the vicinity of the RF structures.

9. The photonic control system of claim 7, wherein the RF network is coupled with the superconducting RF structure capacitively, inductively, or both.

10. The photonic control system of claim 7, wherein the RF network includes a load circuit and a matching circuit.

11. The photonic control system of claim 10, wherein the matching circuit and load circuits are configured so as to match the impedance of the photodetector at the frequency bandwidth of the superconducting RF structure to reduce power consumption.

12. The photonic control system of claim 1, wherein the RF structure is one of a qubit or a readout resonator.

13. The photonic control system of claim 4, where the photonic chip includes a micro-lens array optical coupled to the optical fiber assembly and a tuning mirror to direct the received optical control signal.

14. The photonic control system of claim 4, wherein the optical signal is a wavelength division multiplexed signal and the photonic chip includes an arrayed Wave Grating to demultiplex the wavelength division multiplexed signal to a plurality of RF structures.

15. The photonic control system of claim 1, wherein the optical transmitter system comprises lasers and RF drivers, where the RF drivers are configured to drive the lasers with control signals to drive the superconducting RF structures and wherein the lasers are one of a vertical-cavity surface-emitting laser (VCSEL) or a distributed feedback (DFB) laser.

16. The photonic control system of claim 15, wherein the laser is one of a plurality of lasers are arranged in a linear or 2D grid and are optically coupled to the optical fiber, wherein the optical fiber assembly is one of a multimode optical fiber, a single-mode multicore optical fiber, a 2D multi-fiber, or a fiber ribbon.

17. The photonic control system of claim 1, wherein the optical transmitter system is communicatively coupled with the photodetectors.

18. The photonic control system of claim 16, wherein the optical transmitter system includes a wavelength division multiplexer combiner coupled to the laser to control the RF structures.

19. A photonic system comprising:
at least one optical transmitter system at room temperature configured to generate optical control signals;
a plurality of photonically controlled RF systems at cryogenic temperatures, each of the photonically controlled RF system comprising of a photonic chip and at least one superconducting chip; and
a plurality of optical fiber assemblies coupling the optical control signals generated by the optical transmitter to each of the photonically controlled RF systems.

20. The photonic system of claim 19, wherein the photonic chip comprises a photodetector optically coupled to the optical light source transmitter via the optical fiber assembly, wherein the photodetector configured to convert the optical control signal to an RF signal.

21. The photonic system of claim 19, wherein the at least one superconducting chip comprises one or more superconducting RF structure(s) configured to receive the RF signal responsive to the optical control signal from the photodetector.

22. The photonic system of claim 21, wherein the one or more RF structures are configured to be controlled by the RF signal responsive to the optical control signal.

23. The photonic system of claim 19, wherein the photonic chip and superconducting chip are flip-chip bonded.

24. The photonic system of claim 19, wherein the photonic chip comprises an optical waveguide configured to distribute the optical control signal to the photodetector.

25. The photonic system of claim 19, wherein the output of the photodetector is coupled to the superconducting RF structure via a power optimized RF network comprising resistive, inductive and capacitive elements and where the elements of the RF network are in either a lumped or distributed configuration.

26. The photonic system of claim 19, wherein the photodetector and the optimized RF network are positioned in the vicinity of the RF structure.

27. The photonic system of claim 19, wherein the RF network is coupled with the superconducting RF structure capacitively, inductively, or both.

28. The photonic control system of claim 27, wherein the RF network includes a load circuit and a matching circuit.

29. The photonic control system of claim 28, wherein the matching circuit and load circuits are configured so as to match the impedance of the photodetector at the frequency bandwidth of the superconducting RF structure to reduce power consumption.

30. The photonic control system of claim 19, wherein the RF structure is one of a qubit or a readout resonator.

31. The photonic control system of claim 19, where the photonic chip includes a micro-lens array optical coupled to the optical fiber assembly and a tuning mirror to direct the received optical control signal.
